(19) United States
(12) Patent Application Publication
(10) Pub. No.: US 2008/0261081 A1
(43) Pub. Date: Oct. 23, 2008

(54) PERPENDICULAR MAGNETIC RECORDING MEDIUM AND METHOD OF MANUFACTURING THE SAME

(75) Inventors: Hoo-san Lee, Osan-si (KR); Sung-dong Suh, Seoul (KR); Tae-sang Park, Suwon-si (KR); Hoon-sang Ho, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/108,205

(22) Filed: Apr. 23, 2008

(30) Foreign Application Priority Data
Apr. 23, 2007 (KR) 10-2007-0039439

(51) Int. Cl. G11B 5/706; B05D 5/12

(52) U.S. Cl. 428/846.7; 428/846; 428/846.9; 427/131; 264/400

(57) ABSTRACT

Provided is a perpendicular magnetic recording medium and a method of manufacturing the same. The perpendicular magnetic recording medium includes a substrate, a buffer layer formed on the substrate, a soft magnetic underlayer formed on the buffer layer, and a recording layer formed on the soft magnetic underlayer.

### CROSS-REFERENCE TO RELATED PATENT APPLICATION

This application claims the benefit of Korean Patent Application No. 10-2007-0039439, filed on Apr. 23, 2007, in the Korean Intellectual Property Office, the disclosure of which is incorporated herein in its entirety by reference.

### BACKGROUND OF THE INVENTION

1. Field of the Invention

The present invention relates to a perpendicular magnetic recording medium and a method of manufacturing the same, and more particularly, to a perpendicular magnetic recording medium that includes a substrate, a buffer layer, a soft magnetic lower layer, and a recording layer and a method of manufacturing the same.

2. Description of the Related Art

A perpendicular magnetic recording mechanism has a recording density higher than a horizontal magnetic recording mechanism. Therefore, recently, most hard disc drives (HDDs) employ a perpendicular magnetic recording mechanism to increase recording density. A perpendicular magnetic recording apparatus includes a perpendicular magnetic recording medium and a pole head to perpendicular magnetic recording. The perpendicular magnetic recording medium includes a double magnetic layer that includes a ferromagnetic layer in which a magnetization direction is arranged in a perpendicular direction to a plane and a soft magnetic underlayer.

In the perpendicular magnetic recording medium, the recording layer requires a further reduced grain size to increase recording density. Individual grain size and distances between the grains affect the noise of the medium and recording density. The larger the grain size, the larger the noise. However, there is a physical limitation in reducing the grain size. Thermal stability is also reduced when the grain size is reduced, and grain separation is difficult.

In order to address that above problems, besides the method of controlling the grain size, a method of forming the recording layer using a material having high magnetic anisotropy has drawn attention. An annealing process must be performed in order to use the material having a high magnetic anisotropy as the recording layer. However, a glass substrate and a metal alloy substrate, largely used for the perpendicular magnetic recording medium, are very susceptible to heat. Also, the soft magnetic underlayer formed between the substrate and the recording layer is degraded at a high temperature. Thus, there is a need to develop a method of reducing the effect of heat with respect to the substrate or other thin films during the annealing process.

### SUMMARY OF THE INVENTION

To solve the above and/or other problems, the present invention provides a perpendicular magnetic recording medium that can reduce the effect of heat to a substrate or thin films in a process of annealing a recording layer of the perpendicular magnetic recording medium.

The present invention also provides a method of manufacturing the perpendicular magnetic recording medium.

According to an aspect of the present invention, there is provided a perpendicular magnetic recording medium comprising: a substrate; a buffer layer formed on the substrate; a soft magnetic underlayer formed on the buffer layer; and a recording layer formed on the soft magnetic underlayer.

The buffer layer may have a heat transfer coefficient of 1 to 10 W/mK.

The perpendicular magnetic recording medium can further include a heat blocking layer on the soft magnetic underlayer.

The recording layer may be formed of a material having a L1₀ structure.

According to an aspect of the present invention, there is provided a method of manufacturing a perpendicular magnetic recording medium comprising: forming a buffer layer on a substrate; forming a soft magnetic underlayer on the buffer layer; forming a recording layer on the soft magnetic underlayer; and annealing the recording layer.

The recording layer may be annealed using a laser annealing method or a rapid thermal annealing (RTA) method.

The method of manufacturing a perpendicular magnetic recording medium may further comprise forming a heat blocking layer between the forming of the soft magnetic underlayer and the forming of the recording layer.

### BRIEF DESCRIPTION OF THE DRAWINGS

The above, other features, and advantages of the present invention will become more apparent by describing in detail exemplary embodiments thereof with reference to the attached drawings in which:

FIG. 1 is a cross-sectional view of a perpendicular magnetic recording medium according to an embodiment of the present invention;

FIG. 2 is a cross-sectional view of a perpendicular magnetic recording medium that further includes a heat blocking layer according to an embodiment of the present invention; and

FIGS. 3A through 3D are cross-sectional views illustrating a method of manufacturing a perpendicular magnetic recording medium according to an embodiment of the present invention.

### DETAILED DESCRIPTION OF THE INVENTION

The present invention will now be described more fully with reference to the accompanying drawings in which exemplary embodiments of the invention are shown. In the drawings, the thicknesses of layers and regions are exaggerated for clarity.

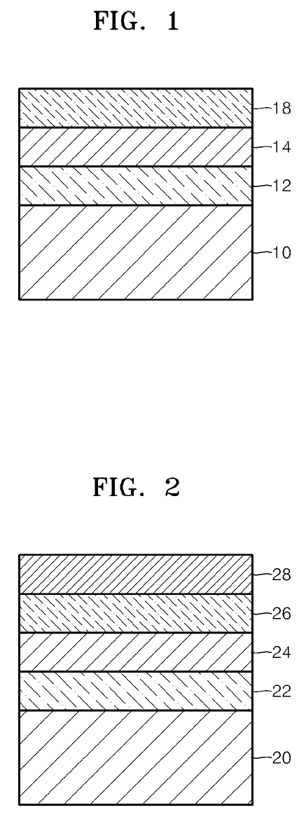

FIG. 1 is a cross-sectional view of a structure of a perpendicular magnetic recording medium according to an embodiment of the present invention.

Referring to FIG. 1, in a perpendicular magnetic recording medium according to the present embodiment, a buffer layer 12 is formed on a substrate 10, a soft magnetic underlayer 14 is formed on the buffer layer 12, and a recording layer 18 is formed on the soft magnetic underlayer 14.

An intermediate layer (not shown) that increases the crystal orientation of the recording layer 18 can be formed on the soft magnetic underlayer 14. A protection film (not shown) formed by including diamond-like carbon (DLC) to protect the recording layer 18 can further be formed on the recording layer 18. Also, a lubrication layer (not shown) for reducing wear of a magnetic head of a HDD due to collision and sliding between the magnetic head and the protection film can further be formed on the recording layer 18.

The substrate 10 can be formed of a material selected from the group consisting of an Al alloy substrate, a glass substrate, and a plastic substrate.

The soft magnetic underlayer 14 forms a magnetic path, of a perpendicular magnetic field, between the recording layer 18 and the substrate 10 to record information in the recording layer 18. The soft magnetic underlayer 14 can also be formed of a magnetic material such as CoZrNb or CoFeB.

The recording layer 18 is a perpendicular magnetic recording layer and can be formed of a material having a L1₀ structure. In order to increase recording density, the recording layer 18 can be formed of a material having high magnetic anisotropy, for example, a transition material or a Co alloy. The Co alloy can be CoPt or FePt having a L1₀ structure.

When the recording layer 18 is formed using a material having a high magnetic anisotropy, the magnetic anisotropy is very low immediately after a thin film is formed due to irregular structure. However, a high magnetic anisotropy can be obtained by annealing the thin film in the course of forming the thin film or after forming the thin film so that the thin film can have a L1₀ structure. However, the annealing process, for causing a phase transformation from an irregular structure to a regular structure, is performed at a temperature of 400° C. or more, and thus, the annealing process can also affect other layers. Studies have been conducted to reduce the annealing process temperature and to heat the surface of the recording layer 18. However, the perpendicular magnetic recording medium, having a thickness of 100 nm to 200 nm, is stacked on the surface of the substrate 10. Thus, when annealing the recording layer 18, the substrate 10 or other thin films can be affected, or the recording layer 18 can be affected by the substrate 10 or other thin films.

The buffer layer 12 formed on the substrate 10 prevents the substrate 10 from being transformed, due to high temperature in the process of annealing the recording layer 18, to have a L1₀ structure. This process of annealing the recording layer 18 also prevents the diffusion of impurities contained in the substrate 10 into the soft magnetic underlayer 14. The buffer layer 12 has a thermal transfer coefficient of 1 W/mK to 10 W/mK, and can be formed of a material that is thermally stable at a temperature between 300 and 1000° C. The buffer layer 12 can be formed of an oxide or a nitride, more specifically, can be formed of SiO₂ or Al₂O₃. The buffer layer 12 may have a thickness of 100 nm to 3000 nm.

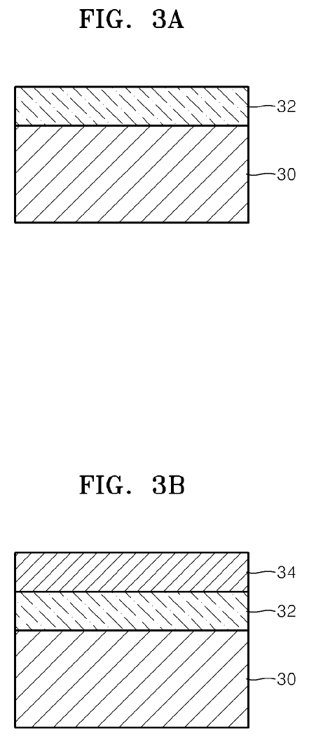

FIG. 2 is a cross-sectional view of a perpendicular magnetic recording medium that further includes a heat blocking layer 26 according to an embodiment of the present invention. A recording layer 28, a soft magnetic underlayer 24, a buffer layer 22, and a substrate 20 are respectively identical to the recording layer 18, the soft magnetic underlayer 14, the buffer layer 12, and the substrate 10, and thus, detailed descriptions thereof will not be repeated.

Referring to FIG. 2, the perpendicular magnetic recording medium further includes the heat blocking layer 26 between the recording layer 28 and the soft magnetic underlayer 24.

Since the recording layer 28 has a thickness of 10 nm to 30 nm, heat can be transferred from the recording layer 28 to the soft magnetic underlayer 24 during the annealing process. Also, since the soft magnetic underlayer 24 is formed of a metal having high heat transfer, impurities can enter the soft magnetic underlayer 24, and as a result, the surface roughness of the soft magnetic underlayer 24 can be changed. Thus, the recording characteristics of the soft magnetic underlayer 24 can be changed. As described above, in order to prevent the soft magnetic underlayer 24 from being affected by heat during the annealing process, a heat blocking layer 26 can further be included in the perpendicular magnetic recording medium.

The heat blocking layer 26 can be formed of a material that has a heat transfer coefficient of 1 to 10 W/mK and is stable at a temperature of 300 to 1000° C. The heat blocking layer 26 can be formed of an oxide or a nitride, for example, SiO₂ or Al₂O₃, and can have a thickness of 10 to 30 nm.

An intermediate layer (not shown) for increasing the orientation of the recording layer 28 can further be formed between the heat blocking layer 26 and the recording layer 28.

The intermediate layer can be formed of Ru.

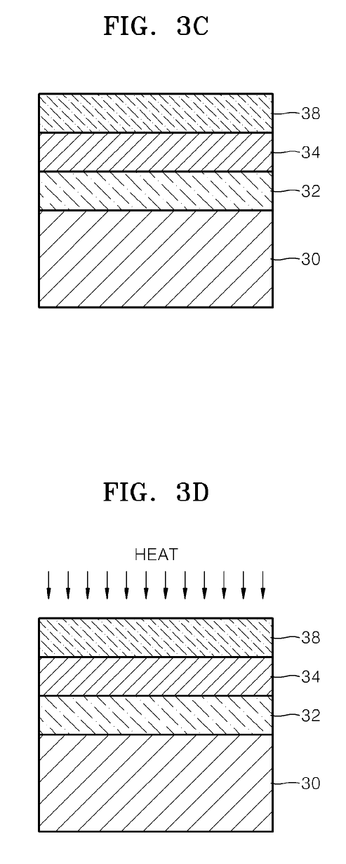

FIGS. 3A through 3D are cross-sectional views illustrating a method of manufacturing a perpendicular magnetic recording medium according to an embodiment of the present invention.

Referring to FIGS. 3A through 3D, a method of manufacturing the perpendicular magnetic recording medium includes sequentially forming a buffer layer 32, a soft magnetic underlayer 34, and a recording layer 38 on a substrate 30 and annealing the resultant product.

Referring to FIG. 3A, the buffer layer 32, an oxide or a nitride, is formed on the substrate 30 to a thickness of 100 to 3000 nm. Also, the buffer layer 32 can be formed of a material that has a heat transfer coefficient of 1 to 10 W/mK and is thermally stable at a temperature of 300 to 1000° C. The buffer layer 32 can be formed using a sputtering method, a chemical vapour deposition (CVD) method, a vacuum evaporation method, or a laser ablation method. When the buffer layer 32 is formed using the sputtering method, the buffer layer 32 can be formed using a silicon target under at an oxygen atmosphere.

Referring to FIG. 3B, the soft magnetic underlayer 34, having a thickness of approximately 100 nm and using a magnetic material such as CoZrNb or CoFeB, is formed on the buffer layer 32.

Referring to FIG. 3C, the recording layer 38 is formed on the soft magnetic underlayer 34 using a vacuum evaporation method, an electroplating method, a CVD method, or a sputtering method. The recording layer 38 can be formed to a thickness of 10 to 30 nm using CoPt or FePt.

Referring to FIG. 3D, a L1₀ structure that has high magnetic anisotropy is formed by annealing the recording layer 38. The annealing method can be a laser annealing method or a rapid thermal annealing (RTA) method. When the recording layer 38 is annealed using the laser annealing method, the annealing can be performed for 1 to 2 μsec at a laser power of 150 to 250 mW. When the recording layer 38 is annealed using the RTA method, the annealing temperature can be 300 to 600° C.

According to an embodiment of the present invention, in order to address the heat transfer problem between the recording layer 38 and the soft magnetic underlayer 34, forming a heat blocking layer (not shown) can additionally be included in the method of manufacturing the perpendicular magnetic recording medium. The forming of the heat blocking layer is performed after the soft magnetic underlayer 34 is formed and before forming the recording layer 38.

The heat blocking layer can be formed of a material that has a heat transfer coefficient of 1 to 10 W/mK and is stable at a temperature of 300 to 1000° C. The heat blocking layer can be formed to a thickness of 10 to 30 nm using an oxide or a nitride such as SiO₂ or Al₂O₃.

The heat blocking layer can be formed using a sputtering method, a CVD method, a vacuum evaporation, or a laser ablation method. In this case, a silicon target can be used under an oxygen atmosphere.

As described above, according to the present invention, a perpendicular magnetic recording medium that can reduce the effect of heat to other layers during an annealing process of a recording layer can be manufactured.

According to the method of manufacturing a perpendicular magnetic recording medium of the present invention, the recording characteristics of the perpendicular magnetic recording medium can be increased.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A perpendicular magnetic recording medium comprising:
a substrate;
a buffer layer formed on the substrate;
a soft magnetic underlayer formed on the buffer layer; and
a recording layer formed on the soft magnetic underlayer.

2. The perpendicular magnetic recording medium of claim 1, wherein the buffer layer has a heat transfer coefficient of 1 to 10 W/mK.

3. The perpendicular magnetic recording medium of claim 1, wherein the buffer layer performs as a heat blocking layer.

4. The perpendicular magnetic recording medium of claim 1, wherein the buffer layer performs as a diffusion prevention layer.

5. The perpendicular magnetic recording medium of claim 1, wherein the buffer layer is formed of an oxide or a nitride.

6. The perpendicular magnetic recording medium of claim 5, wherein the buffer layer is formed of SiO₂ or Al₂O₃.

7. The perpendicular magnetic recording medium of claim 1, wherein the buffer layer has a thickness of 100 to 3000 nm.

8. The perpendicular magnetic recording medium of claim 1, wherein the recording layer has a L1₀ structure.

9. The perpendicular magnetic recording medium of claim 8, wherein the recording layer is formed of CoPt or FePt.

10. The perpendicular magnetic recording medium of claim 1, further comprising a heat blocking layer between the soft magnetic underlayer and the recording layer.

11. The perpendicular magnetic recording medium of claim 10, wherein the heat blocking layer has a heat transfer coefficient of 1 to 10 W/mK.

12. The perpendicular magnetic recording medium of claim 10, wherein the heat blocking layer is formed of an oxide or a nitride.

13. The perpendicular magnetic recording medium of claim 12, wherein the heat blocking layer is formed of SiO₂ or Al₂O₃.

14. The perpendicular magnetic recording medium of claim 10, wherein the heat blocking layer has a thickness of 10 to 30 nm.

15. The perpendicular magnetic recording medium of claim 1, wherein the substrate is selected from the group consisting of an aluminum substrate, a glass substrate, and a plastic substrate.

16. The perpendicular magnetic recording medium of claim 1, further comprising an intermediate layer between the soft magnetic underlayer and the recording layer.

17. The perpendicular magnetic recording medium of claim 14, wherein the intermediate layer is formed of Ru.

18. A method of manufacturing a perpendicular magnetic recording medium, comprising:
forming a buffer layer on a substrate;
forming a soft magnetic underlayer on the buffer layer;
forming a recording layer on the soft magnetic underlayer; and
annealing the recording layer.

19. The method of claim 18, wherein the buffer layer is formed using a sputtering method, a chemical vapour deposition (CVD) method, a vacuum evaporation method, or a laser ablation method.

20. The method of claim 18, wherein the recording layer has a L1₀ structure.

21. The method of claim 18, wherein the recording layer is formed of CoPt or FePt.

22. The method of claim 18, wherein the recording layer is annealed using a laser annealing method or a rapid thermal annealing (RTA) method.

23. The method of claim 22, wherein the recording layer is annealed for 1 to 2 μsec at a power of 150 to 250 mW using the laser annealing method.

24. The method of claim 22, wherein the recording layer is annealed at a temperature of 300 to 600° C. using the RTA method.

25. The method of claim 18, further comprising forming a heat blocking layer between the forming of the soft magnetic underlayer and the forming of the recording layer.
